(19) United States
(12) Patent Application Publication
(10) Pub. No.: US 2019/0269114 A1
(43) Pub. Date: Sep. 5, 2019

(54) Fish Attractant Dispensing Fishing Lure

(71) Applicants: Kevin A. Biggs, Rose Hill, KS (US); Georgia A. Biggs, Rose Hill, KS (US)

(72) Inventor: Kevin A. Biggs, Rose Hill, KS (US)

(73) Assignees: Kevin A. Biggs, Rose Hill, KS (US); Georgia A. Biggs, Rose Hill, KS (US)

(21) Appl. No.: 16/414,544

(22) Filed: May 16, 2019

(51) Int. Cl. A01K 85/16

(52) U.S. Cl. CPC A01K 85/16; A01K 85/02

(57) ABSTRACT

A fishing lure incorporating a flexible elastomeric body having an outer surface, having a rostral end, a caudal end, a dorsal end, a ventral end, a dextral side, and a sinistral side, wherein the outer surface sculpturally portrays a bait fish body; a hook point passageway positioned within the flexible elastomeric body and extending caudally from the body's rostral end; a cavity having a rostral end and having dextral and sinistral sides, the cavity ventrally underlying the hook point passageway; an intake channel communicating with the cavity and extending to the flexible elastomeric body's outer surface; and a first outlet channel communicating with the cavity and extending to the flexible elastomeric body's outer surface.

### FIELD OF THE INVENTION

This invention relates to fishing lures of the type which incorporate barbed fish hooks. More particularly, this invention relates to such lures which are adapted for dispensing fish attractants into the water.

### BACKGROUND OF THE INVENTION

Known fishing lures which are adapted for emitting fish attractants during fishing commonly inefficiently dispense their attractants media and are commonly are difficult to assemble and use.

The instant inventive fishing lure solves or ameliorates such problems, defects, and deficiencies by providing a fishing jig and jig body combination wherein the jig body component is specially configured for receipt and positioning of such combination's hook over a ventrally positioned fish attractant cavity, and by specially configuring structures associated with the cavity for efficient dispensation of the attractant.

### BRIEF SUMMARY OF THE INVENTION

A first structural component of the instant inventive fishing lure comprises a flexible elastomeric body. In a preferred embodiment, the body component initially comprises liquid plastisol or a liquid suspension of polyvinyl chloride (or other polymer) within a plasticizer such as an ester of phthalic acid. Upon injection of such PVC suspension into a lure body mold, heating for thermosetting and subsequent cooling beneficially produces the invention's flexible elastomeric body component.

The instant invention's flexible elastomeric body component has an outer surface having a rostral end, a caudal end, a dorsal end, a ventral end, a dextral side, and a sinistral side. In the preferred embodiment, the outer surface of the body is specially configured so that it sculpturally portrays or depicts a body of a living bait fish such as a minnow.

A further structural component of the instant inventive fishing lure comprises a hook point passageway positioned within the flexible elastomeric body. Such passageway may constitute a continuous matrix of, for example, the plastisol material of the flexible elastomeric body, such passageway preferably extending caudally from the body's rostral end. Function of the invention's hook point passageway are further described below.

A further structural component of the instant inventive fishing lure comprises a hollow interior cavity having a rostral end and having a dextral and sinistral sides. In the preferred embodiment, the interior cavity component is positioned downwardly or ventrally from the hook point passageway so that the cavity ventrally underlies such passageway.

A further structural component of the instant inventive fishing lure comprises an intake channel which passes through the flexible elastomeric body for communication with the interior cavity. In the preferred embodiment, such channel extends rostrally from the cavity to the flexible elastomeric body's outer surface.

A further structural component of the instant inventive fishing lure comprises at least a first outlet channel which communicates with the interior cavity, such channel extending to the flexible elastomeric body's outer surface.

In use of the instant inventive fishing lure, the hook of a lead headed fishing jig may be piercingly extended through and along the body's hook point passageway, preferably without entering or interfering with the underlying interior cavity. A water absorbent matrix laced or impregnated with a fish attractant may be inserted into and through the intake channel to reside within the cavity. Upon fishing line actuated drawing of the lead headed jig and combination during active fishing, water may enter the intake channel to enter the interior cavity, flooding the absorbent matrix and dissolving fish attractant contained therein. Portions of the water including dissolved fish attractant substantially automatically emit through the at least first outlet channel, effectively and beneficially scenting the water surrounding the lure. Fish are attracted by the attractant's scent to the vicinity of the lure allowing the fish to visually identify and strike the lure.

In a preferred embodiment of the instant inventive fishing lure, the matrix of absorbent material within the cavity may initially comprise compressed bodies of water absorbent or hydrophillic elastomeric foam or sponge material which are temporarily encased within one or more water soluble gelatin capsules. In such embodiment, small amounts of various fish attractants may be simultaneously temporarily contained within the capsules, the attractants residing within the compressed cellular spaces of the matrices. Such capsules are preferably sized so that they may be inserted into the open outer end of the intake channel, and thence manually pressed therethrough to reside within the cavity.

Upon soaking the assembled fishing lure in water, such inserted capsule automatically dissolves, allowing its attractant impregnated matrix to expand to fill the interior space of cavity. Further introductions of water into and through the cavity carries the attractant through the matrix for outward dispensation at the at least first outlet channel and into the surrounding water. A plurality of outlet channels are preferably provided.

Accordingly, objects of the instant invention include the provision of a fishing lure which incorporate structures as described above, and which arranges those structures in relation to each other in manners described above for the achievement of beneficial functions described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of a preferred embodiment of the instant inventive fishing lure.

FIG. 2 is a sectional view, as indicated in FIG. 1.

FIG. 3 is an alternative sectional view, as indicated in FIG. 1.

FIG. 4 is a perspective view of a water soluble capsule component of the instant inventive fishing lure.

FIG. 5 is a sectional view as indicated in FIG. 4.

FIG. 6 redepicts the structure of FIG. 2, the view of FIG. 6 further showing an incorporation of the FIG. 4 structure.

FIG. 7 includes a side view of a lead headed jig component prior to its insertion into the invention's body component.

FIG. 8 redepicts the structure of FIG. 6, the view of FIG. 8 showing a hydrophillic matrix filling the body's interior cavity component.

### DETAILED DESCRIPTION OF A PREFERRED EMBODIMENT

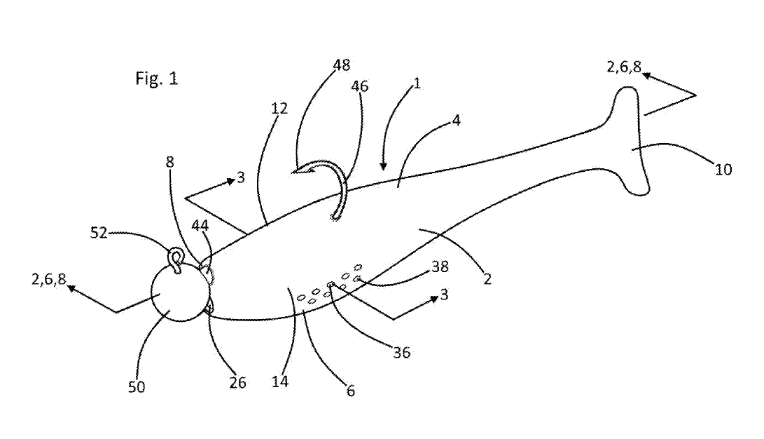

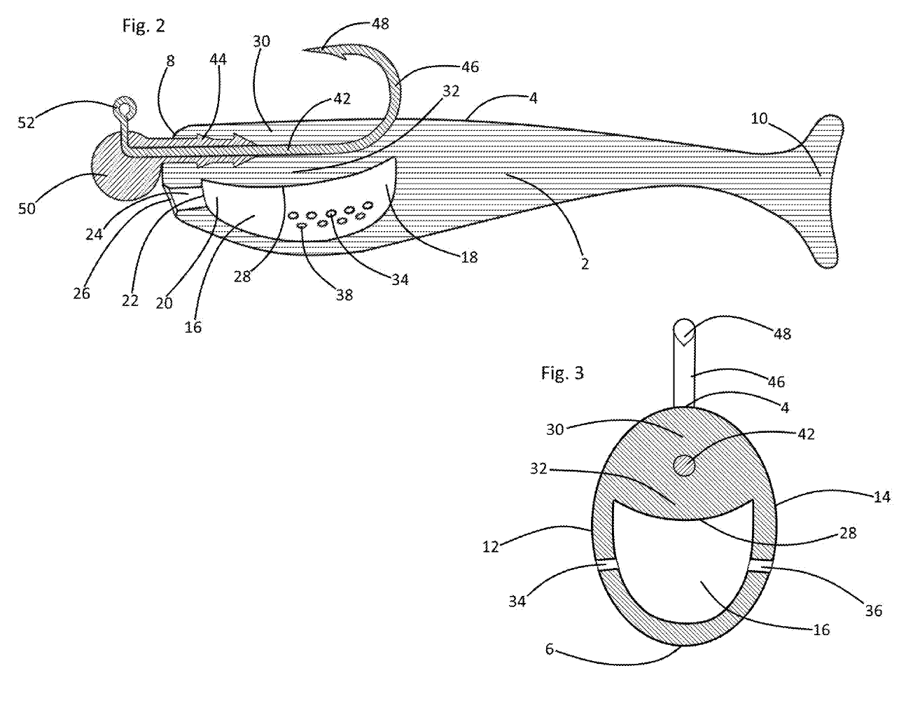

Referring now to the drawings and in particular to Drawing FIGS. 1 and 2, a preferred embodiment of the instant inventive fishing lure is referred to generally by Reference Arrow 1. The fishing lure 1 comprises a flexible elastomeric body 2 having an outer surface (e.g., portions of the body 2 which are visible in the view of FIG. 1), a rostral end 8, caudal end 10, a dorsal end 4, a ventral end 6, a dextral side 12, and a sinistral side 14. As indicated in FIG. 1, the outer surface of the flexible elastomeric body 2 is preferably specially configured so that it depicts or sculpturally portrays a bait fish body. The fish shape of body 2 is intended to be representative of all types of commonly known bait fish.

A further structural component of the instant inventive fishing lure comprises a hook point passageway 30 which is preferably positioned at the rostral and dorsal ends of the body 2. In the preferred embodiment, such passageway 30 extends caudally from the extreme rostral end 8 of the body 2.

A further structural component of the instant inventive fishing lure comprises a hollow interior cavity 16 which, consonantly with the body 2, has a caudal end 18, and a rostral end 20. In the preferred embodiment, the cavity 16 is positioned so that it ventrally underlies the hook point passageway 30.

A further structural component of the instant inventive fishing lure comprises an intake channel 24 which communicates with the hollow interior cavity 16. In the preferred embodiment, the intake channel 24 extends rostrally from a rostral cavity opening 22 to a second opening 26 at the extreme rostral end of the body 2. The invention's rostral end opening 26 preferably has a chamfered or flared peripheral lip whose function is discussed below.

A further structural component of the instant inventive fishing lure comprises at least a first outlet channel or dextral channel 34 which communicates with the cavity 16 and which extends to the outer surface of the flexible elastomeric body 2. A second or sinistral outlet channel 36 may be provided and, preferably, a plurality of third outlet channels 38 are provided.

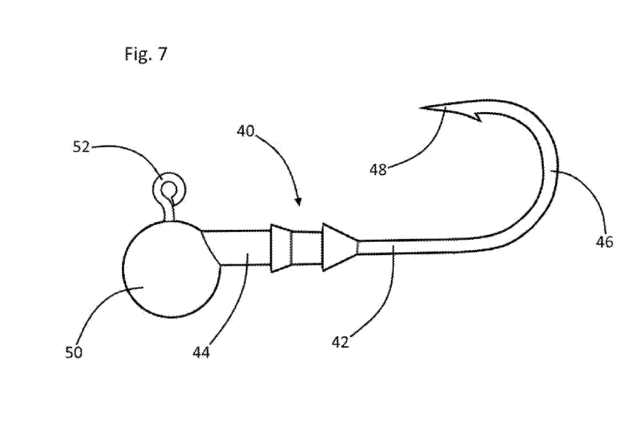

Referring simultaneously to FIGS. 1, 2, 3 and 7, assembly of the instant inventive fishing lure preferably incorporates a lead headed fishing jig 40. Such jig 40 preferably includes a shank or mounting pin portion 42,44, a hook or curved tail portion 46, a point 48, a fish head portraying or depicting lead head 50, and a line attachment eye 52. In assembling the lure, a fisherman may initially grasp the body 2 in one hand, and may grasp jig 40 in the other. Thereafter, the fisherman may position the point 48 directly against the extreme rostral end 8 of the body 2. Thereafter, the fisherman may manually drive the point 48 in the caudal direction into and through the hook point passageway 30. In order to guard against an entry of such point 48 into the cavity 16, it is preferred that the lower end 32 of the passageway 30 be ventrally or downwardly curved, and that the ceiling 28 of the cavity 16 commensurately be convex. Such preferred ventral curvatures of structures 28 and 32 assures that, as the hook point 48 arcuately travels caudally through passageway 30, the hook point 48 will not enter or tear across ceiling 28. Upon the mounting of the jig 40 in the configuration depicted in FIG. 2, the hook shank 42,42 portion of the jig 40 constitutes and functions as a mounting pin which beneficially secures the lead head 50 at the rostral end of the body 2.

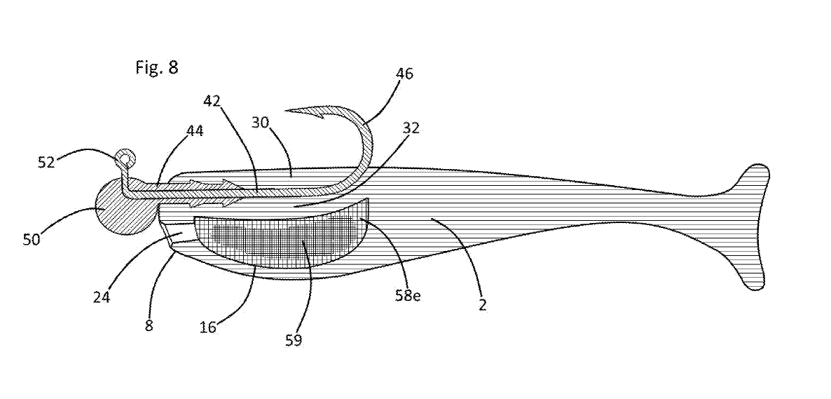

Referring further simultaneously to FIG. 8, the assembly of the instant inventive fishing lure may further incorporate an insertion of an open or cellular matrix of hydrophillic or water absorbent material 58e within the cavity 16. In the preferred embodiment, the matrix of hydrophillic material 58e is composed of elastomeric foam material or sponge material. In further assembly of the instant inventive fishing lure, a fish attractant such as anise, garlic powder or oil, or fish oil 59 may be incorporated so that the matrix 58e becomes impregnated with the attractant.

Referring simultaneously to FIGS. 1-3 and 8, in use of the inventive fishing lure following assembly as described above, a fisherman may initially tie his or her fishing line to eye 52. Thereafter, the lure 1 may be cast into a pond or lake. Thereafter, drawing of the lure 1 via reeling or trolling may commence. During such active fishing use of the lure 1, lake or pond water passes through rostral opening 26, thence through channel 24, and thence further caudally through the rostral opening 22 of the cavity 16. Thereafter, the water floods and passes through the cavity 16, mixing with the fish attractant 59 and emitting dextrally and sinistrally through the preferably first, second, and third outlet channels 34, 36, and 38. Such water passage and emission carries portion of the fish attractant 58e, effectively scenting the surrounding waters enhancing the rate of strikes against the lure.

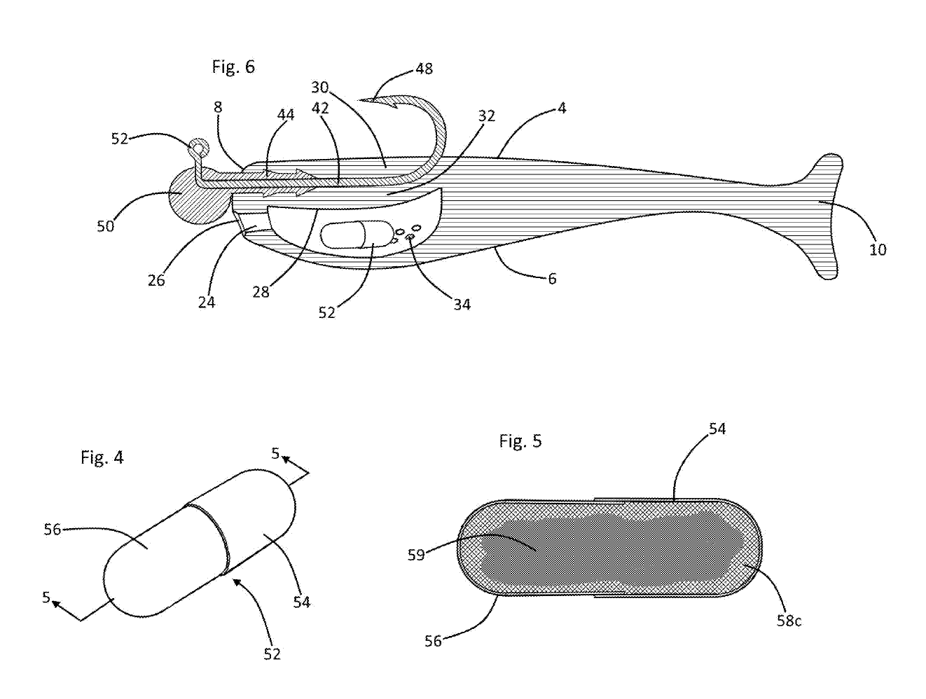

Referring simultaneously to FIGS. 4, 5, 6, and 8, the matrix of hydrophillic material 58e may be initially reside within the interior space of a water soluble gelatin capsule such as is referred to generally by Reference Arrow 52. Such capsule 52 preferably has slidably nesting halves 54 and 56 which allow matrix materials to be initially contained within the capsule. The matrix 58e is necessarily initially compressed in order to reside within the smaller volume of the interior of the capsule 52. In such compressed configuration, such matrix is referred to in FIG. 5 by Reference Numeral 58c. The cavity deployed fish attractant 59 of FIG. 8 may similarly initially reside along with the matrix 58c within the interior of the capsule 52.

As may be seen in FIG. 6, the lateral cross sectional or outside diameter of the capsule 52 is preferably greater than the inside diameter of intake channel 24, such differential in dimensions assuring that, upon insertion of the capsule 52 into cavity 16, the capsule 52 may not escape therefrom. The flared rostral lip 26 of the channel 24 advantageously allows a rounded end of the capsule 52 to be pressed thereagainst, and to be manually driven in the caudal direction. Application of such manual pressure against the capsule 52 allows its curved end to act as a mandrel which dilates channel 24, allowing the capsule 52 to be completely inserted therethrough.

In operation of the instant invention, while the fishing lure 1 and its interior cavity 16 remain dry, a provided capsule 52 residing therein remains undissolved and intact, such capsule continuing to contain its compressed attractant impregnated matrix 58c. Upon soaking of the lure 1 within water, the water soluble shell 54,56 of the capsule 52 dissolves and allows the water absorbent matrix 58c to expand from its FIGS. 4-6 configuration to the FIG. 8 configuration which substantially completely fills the cavity 16. Upon such water actuated matrix expansion, the fish attractant 59 beneficially resides within cavity 16, ready for fish attracting use.

In a preferred embodiment of the instant invention, several capsules configured similarly with the capsule 52 may be provided for use by a fisherman utilizing a single rendition of the lure 1, such additional capsules suitably including a selection of different types of fish attractant. In use, the provided multiple capsules may be labeled or color coded to indicate the various fish attractants contained therein. A fisherman may advantageously successively select among, and use such capsules in a manner of testing for attractant effectiveness.

In order to interchange matrices 58e and fish attractants 59 within cavity 16, it is preferred that the material composition of the matrix 58e have a tensile or tear resistant strength which is sufficient to allow a barb of a fish hook point, such as the barb of the hook point 48, to snare the matrix 58e and rostrally withdraw the matrix through intake channel 24. Following such extraction of matrix 58e, a differently scented capsule 52 may be inserted and used within the single body 2.

While the principles of the invention have been made clear in the above illustrative embodiment, those skilled in the art may make modifications to the structure, arrangement, portions and components of the invention without departing from those principles. Accordingly, it is intended that the description and drawings be interpreted as illustrative and not in the limiting sense, and that the invention be given a scope commensurate with the appended claims.

The invention hereby claimed is:

1. A fishing lure comprising:
(a) a flexible elastomeric body having an outer surface, having a rostral end, a caudal end, a dorsal end, a ventral end, a dextral side, and a sinistral side, wherein the outer surface sculpturally portrays a bait fish body;
(b) a hook point passageway within the flexible elastomeric body, said passageway extending caudally from said body's rostral end;
(c) a cavity having a rostral end and having dextral and sinistral sides, the cavity ventrally underlying the hook point passageway;
(d) an intake channel communicating with the cavity, said channel extending to the flexible elastomeric body's outer surface; and
(e) a first outlet channel communicating with the cavity, said channel extending to the flexible elastomeric body's outer surface.

2. The fishing lure of claim 1 comprising a head depicting member positioned rostrally from the flexible elastomeric body's rostral end, and further comprising an anchor pin fixedly attached to and extending caudally from the head depicting member, wherein the anchor pin extends through the hook point passageway.

3. The fishing lure of claim 2 further comprising a fish hook having a tail and a shank, wherein said hook's tail protrudes dorsally from the flexible elastomeric body's dorsal end, and wherein said hook's shank comprise the anchor pin.

4. The fishing lure of claim 3 wherein the intake channel further extends rostrally toward the flexible elastomeric body's rostral end.

5. The fishing lure of claim 4 wherein the intake channel further extends caudally toward the cavity's rostral end.

6. The fishing lure of claim 5 wherein the first outlet channel extends dextrally.

7. The fishing lure of claim 6 further comprising a second outlet channel extending sinistrally from the cavity.

8. The fishing lure of claim 7 further comprising a plurality of third outlet channels, each such channel communicating with the cavity.

9. The fishing lure of claim 3 wherein the hook point passageway has a ventrally curving ventral end.

10. The fishing lure of claim 9 wherein the cavity has a ceiling comprising the hook point passageway's ventrally curving ventral end.

11. The fishing lure of claim 10 further comprising a hydrophillic elastic matrix positioned within the cavity.

12. The fishing lure of claim 11 further comprising a water soluble capsule, the hydrophillic elastic matrix being further positioned within the water soluble capsule.

13. The fishing lure of claim 12 wherein the water soluble capsule has an outside diameter, wherein the intake channel has an inside diameter, and wherein said outside diameter is greater than said inside diameter.

14. The fishing lure of claim 12 wherein the hydrophillic elastic matrix is impregnated with a fish attractant.

15. A fishing lure comprising:
(a) a body having an interior cavity;
(b) at least a first port opening the interior cavity;
(c) a hydrophillic elastic matrix positioned within the cavity;
(d) a water soluble capsule, the hydrophillic elastic matrix being further positioned within said capsule; and
(e) at least a first fish hook attached to the body.

16. The fishing lure of claim 15 wherein the hydrophillic elastic matrix is impregnated with a fish attractant.
